(19) United States
(12) Patent Application Publication
(10) Pub. No.: US 2021/0027629 A1
(43) Pub. Date: Jan. 28, 2021

(54) BLIND AREA PROCESSING FOR AUTONOMOUS DRIVING VEHICLES

(71) Applicant: Baidu USA LLC, Sunnyvale, CA (US)

(72) Inventors: Jiaming Tao, Sunnyvale, CA (US); Yifei Jiang, Sunnyvale, CA (US); Yajia Zhang, Sunnyvale, CA (US); Jiangtao Hu, Sunnyvale, CA (US); Jiacheng Pan, Sunnyvale, CA (US); Jinyun Zhou, Sunnyvale, CA (US); Hongyi Sun, Sunnyvale, CA (US)

(21) Appl. No.: 16/522,515

(22) Filed: Jul. 25, 2019

(51) Int. Cl. G08G 1/16; G05D 1/00; G05D 1/02; G08G 1/01; G08G 1/052

(52) U.S. Cl. CPC G08G 1/166; G05D 1/0088; G05D 2201/0213; G08G 1/0125; G08G 1/052; G05D 1/0214

(57) ABSTRACT

According to one embodiment, a driving environment surrounding an ADV is perceived based on sensor data obtained from various sensors mounted on the ADV including detecting one or more obstacles. The obstacles of the detected obstacles are determined and tracked based on the perception process, where the obstacle states of the obstacles may be maintained in an obstacle state buffer associated with the obstacles. When it is detected that a first moving obstacle is blocked by an object by the sensors, the further movement of the first moving obstacle is predicted based on the prior obstacle states of the first moving obstacle, while the first moving obstacle is blocked in view by the object. A trajectory is planned for the ADV in view of the predicted movement of the first moving obstacle while the first moving obstacle is in the blind area.

### TECHNICAL FIELD

Embodiments of the present disclosure relate generally to operating autonomous driving vehicles. More particularly, embodiments of the disclosure relate to blind area processing for planning and control in driving a vehicle autonomously.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Motion planning and control are critical operations in autonomous driving. However, conventional motion planning operations estimate the difficulty of completing a given path mainly from its curvature and speed, without considering the differences in features for different types of vehicles. Same motion planning and control is applied to all types of vehicles, which may not be accurate and smooth under some circumstances.

An autonomous driving vehicle (ADV) uses onboard sensors to perceive the vehicle's surroundings. In some cases, this perception can become limited or hampered. For example, sensors can be obstructed by a static obstacle such as a building, wall, or other objects. Similarly, dynamic obstacles such as a truck, vehicle, or other moving object can obstruct the sensors. The obstructions can cause a ‘blind area’ for the ADV which can be problematic. For example, the ADV may ignore the blind area, or treat the area as not having a moving object of interest, which can be false. Rather, a moving object, such as another vehicle, a pedestrian, a cyclist, etc. may be in the blind area, and the ADV should react accordingly, e.g., by changing path, steering left or right, or altering speed. Therefore, it is beneficial to provide an ADV solution to address blind area problems. This can further improve safety of autonomous driving.

### BRIEF DESCRIPTION OF THE DRAWINGS

Embodiments of the disclosure are illustrated by way of example and not limited by figures of the accompanying drawings in which like references indicate similar elements.

FIGS. 1A and 1B show blind area processing according to one embodiment.

FIG. 2 shows blind area processing according to one embodiment.

FIG. 3 shows blind area processing with a dynamic obstacle according to one embodiment.

FIG. 4 shows a process for driving autonomously that includes processing blind areas, according to one embodiment.

FIG. 5 is a block diagram illustrating an example of a blind area processing module according to one embodiment.

FIG. 6 is a block diagram illustrating an autonomous driving vehicle according to one embodiment.

FIG. 7 is a block diagram illustrating an example of an autonomous driving vehicle according to one embodiment.

FIG. 8 is a block diagram illustrating an example of a perception and planning system used with an autonomous driving vehicle according to one embodiment.

FIG. 9 is a block diagram illustrating an example of an object tracking system to track movement of objects according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a process computer implemented process for operating an autonomous driving vehicle (ADV) in a ‘blind area’ situation includes detecting a first object and a second object based on sensor information generated by sensors of the ADV. Movement information, such as but not limited to direction, speed, acceleration, or trajectory of the second object can be determined. When it is determined that second object becomes blocked by the first object in a blind area, the process can estimate a position of the second object in the blind area, based on the movement information of the second object which was determined prior to the object becoming blocked.

To elaborate, a blind area can occur when a static or dynamic obstacle blocks the ADV's sensors from perceiving another object of interest (e.g., a pedestrian, a cyclist, an automobile, etc.). The process can include detecting a first object (e.g., a blocking object) and a second object (e.g., a blocked object in a blind area) based on a first set of sensor information generated by one or more sensors. Also based on the first set of sensor information, the process can determine a direction, a speed, acceleration, a trajectory, and/or other movement information of the second object. In other words, in the first set of sensor information, both the first object and the second object are ‘perceived’.

Based on a second set of sensor information (sensed at a time later than the first set), the process can determine that a line of sight of the one or more sensors to the second object is blocked, in the blind area, by the first object. In response, the process can estimate a position of the second object in the blind area, based on the direction, the speed, the acceleration, the trajectory, and/or the other past movement information of the second object that was determined based on the first set of sensor information. The position (or location) can be defined by coordinates such as latitude and longitude coordinates; x and y; x, y, and z; or other coordinates that describe a position of the object, such as on a two-dimensional (2D) or three-dimensional (3D) map. The first set of sensor information is generated at one or more time frames or periods prior to generating the second set of sensor information. The past movement information can determined based sensor information gathered over multiple periods, and is not limited to the time period immediately prior to the blocking of the second object.

In other words, when the second object is deemed to be occluded by a first object, the position of the second object can be determined based on historical movement information of the second object, which can include any combination of past direction/heading, past speed, past acceleration, and past trajectory. The first object (blocking object) can be positioned between the ADV (and sensors thereof) and the second object (blocked object), preventing the ADV sensors from sensing the second object.

The ADV can modify or determine a target position, path, speed, direction, or steering angle of the ADV, based on the estimated position of the second object in the blind area. This can improve autonomous driving safety in blind area situations. It should be understood ‘estimating’ as it relates to the location of the blocked object in the blind area, is used interchangeably with ‘determining’ and ‘calculating’. Similarly, a ‘direction’ is used interchangeably with ‘heading’ with regard to an object in the blind area.

According to one embodiment, a driving environment surrounding an ADV is perceived based on sensor data obtained from various sensors mounted on the ADV including detecting one or more obstacles. The obstacles of the detected obstacles are determined and tracked based on the perception process, where the obstacle states of the obstacles may be maintained in an obstacle state buffer associated with the obstacles. When it is detected that a first moving obstacle is blocked by an object by the sensors (e.g., a blind area of the first moving obstacle due to the object), the further movement of the first moving obstacle is predicted based on the prior obstacle states of the first moving obstacle (e.g., moving history of the first moving obstacle), while the first moving obstacle is blocked in view by the object. A trajectory is planned for the ADV in view of the predicted movement of the first moving obstacle while the first moving obstacle is in the blind area.

In one embodiment, for each of the moving obstacles detected by the perception, an obstacle buffer is allocated to specifically store the obstacle states of the corresponding obstacle. An obstacle state may include one or more of a location, a speed, or a heading direction of an obstacle at a particular point in time. The obstacles states of an obstacle can be utilized to reconstruct a prior trajectory or path that obstacle has traveled. A further movement of the obstacle can be predicted based on the reconstructed trajectory or path. In addition, the lane configuration of lanes and/or traffic flows (e.g., traffic congestion) can also be inferred based on the obstacle states of the moving obstacles in view of the map information, traffic rules, and/or real-time traffic information obtained from a remote server.

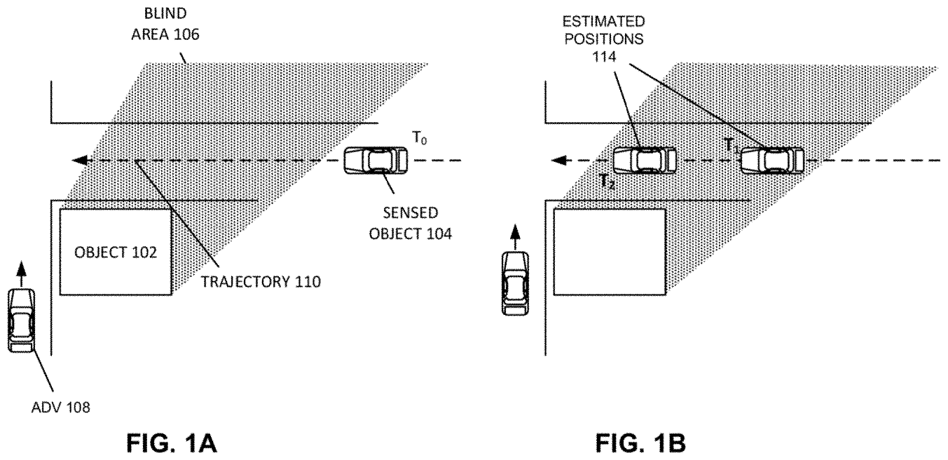

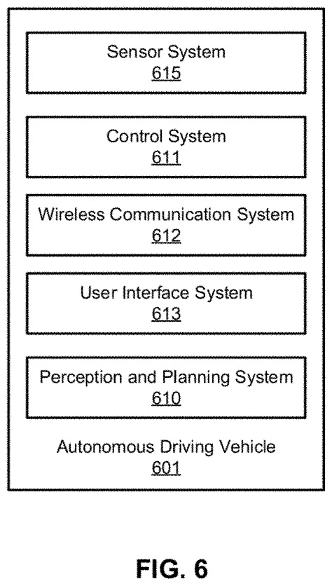

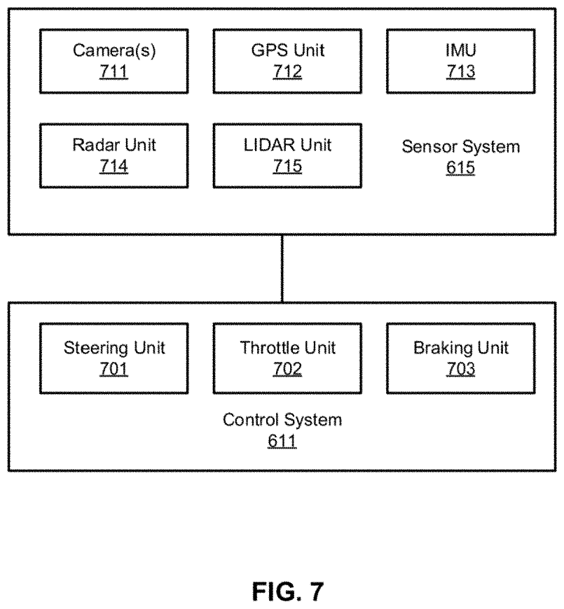

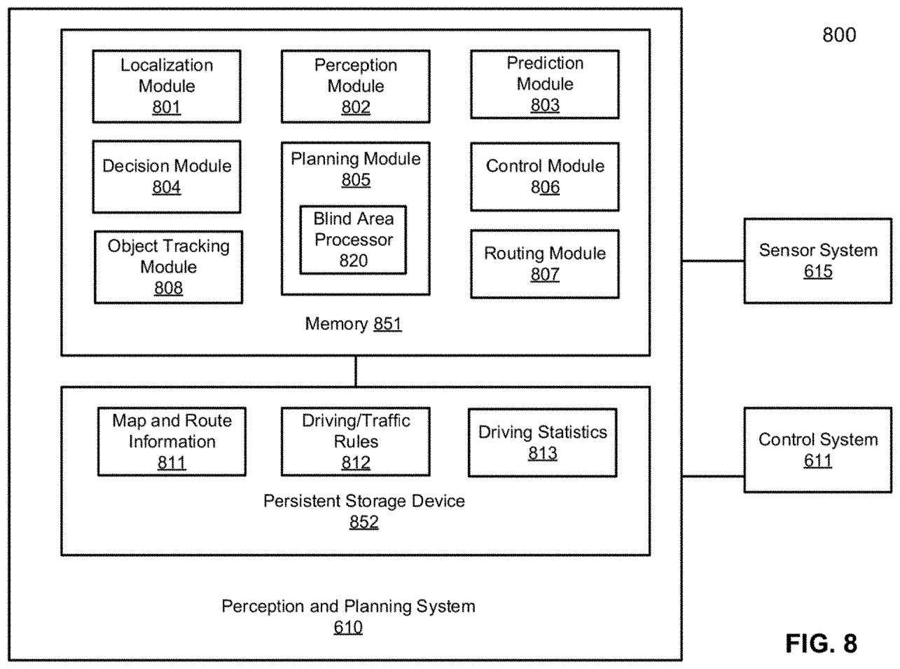

FIG. 1A shows an ADV 108 driving north. At a time to, an object 104 (e.g., a vehicle) is driving east, directly towards a blind area 106. An object 102, which can be static (e.g., a building, tree, bush, or wall) or dynamic (e.g., a truck, or a car), obstructs one or more sensors of the ADV from perceiving blind area 106. The sensors of the ADV can be different combinations of sensor technology, for example, as described in relation to sensor system 615 of FIG. 6, FIG. 7, and FIG. 8. Obstacle 104 can be perceived, monitored, and tracked by ADV 108, and the obstacle states (e.g., location, speed, heading direction) of obstacle 104 can be maintained in an obstacle buffer associated with the obstacle 104.

In FIG. 1B, the object 104 is no longer sensed by the ADV's sensors, as it has presumably moved within the blind area. Based on historical movement data of the object, one or more positions 114 of the object can be estimated. The historical movement data of the object can be based on sensor information from time to and/or other past sensor information (e.g., t₋₁, t₋₂, etc.) to generate average movement data (e.g., an average velocity), determine acceleration/deceleration patterns, and/or determine steering patterns of the object (e.g., where the object is a vehicle) prior to the ‘disappearance’ of the object into the blind area.

A trajectory 110 of the object 104 in the blind area can be determined based on the historical movement data of the object, e.g., a heading at time to. Additionally or alternatively, the trajectory can be determined based on map information (e.g., based on a curvature and orientation of a driving lane, in the blind area, that object 104 was on). The example shown in FIGS. 1A and 1B show the trajectory as straight. The vehicle 104 was perceived by the ADV 108 to be moving straight along the trajectory prior to being blocked. Furthermore, the ADV can utilize map data and prior movement of vehicle 104 to determine that the lane that vehicle 104 is on is straight through the blind area, which further indicates that the trajectory of the vehicle should be straight in the blind area. The prior movement of vehicle 104 can be derived based on the prior obstacle/vehicle states of vehicle 104, which is maintained by ADV 108 for a predetermined period of time.

One or more positions 114 of the blocked object can calculated along the trajectory 110. For example, at t₁, a first position of vehicle 104 can be estimated. Furthermore, at time t₂, a second position of vehicle 104 can be estimated. The positions can be calculated along the trajectory based on a time of capture of the first set of sensor information (e.g., to). For example, an estimated position of the object 104 can be determined along the trajectory based on velocity, time, and an initial position. Thus, a position s₁ of the object at time t₁ can be determined based on position s₀ at time t₀ and velocity v of the object, s₁=s₀+v*(t₁−t₀). It should be understood that this is a simplified example, as the blind area determination of blocked objects can be based on various factors, as discussed in other sections. Other algorithms can be implemented.

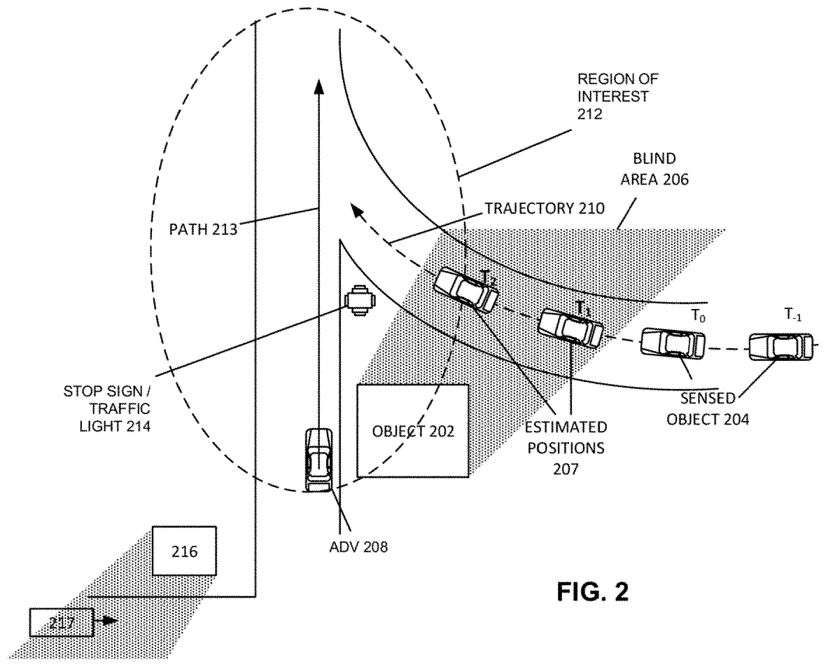

FIG. 2 depicts various aspects of the present disclosure. In this example, an object 204 (e.g., a vehicle) can be sensed at one or more times t₀ and t₁ by ADV 208. Movement information of the object can be determined based on the sensed information. A trajectory 210 of the object in the blind area 206 can be predicted or determined based on the movement data. The trajectory 210 can be arced, following a previously determined are or steering pattern of the object (e.g., based on sensed data such as steering angles and changes in steering angles at times t₀ and t₋₁). One or more estimated positions 207 of the object 204 can be determined, for example, based on the moving history of object 204. For example, positions at times t₁ and t₂ can be based on past movement history such as but not limited to speed, position and/or acceleration of the object at times one or more times t₀ and t₋₁. The estimated positions can be determined along the predicted trajectory 210 of the object.

The position of the object 204 can be estimated further based on map information and traffic rules. For example, if the ADV has map information that describes a curvature and orientation of a road that the object 204 is sensed to be traveling, the blind area processor can determine the trajectory of object based on the known road geometry provided by a map, and/or the heading and steering information of the object prior to entering the blind area 206.

Traffic cues such as intersections, stop signs, traffic lights, and/or other traffic controlling objects 214 can be sensed by the ADV or provided electronically as digital map information. The blind area processor can use such cues, along with known traffic rules, to ‘slow’ the object down or ‘stop’ the object in the blind area. For example, if a stop sign is known to be present in the blind area, the object 204 can be ‘stopped’ and the position estimating algorithm can factor a slow down and/or stop into the calculation. Similarly, if the ADV detects that a traffic light 214 is yellow or red, the BAP algorithm can slow or stop the vehicle.

In one embodiment, the ADV can ignore blind areas and objects that are outside of a region of interest 212. The region of interest can be defined based on proximity to a target path 213 of the ADV (which can be determined based on a destination of the ADV and map information). For example, if a moving object 217 such as vehicle, pedestrian, or bicycle becomes obstructed by a building 216, the blind area processor and ADV can ignore the moving object rather than calculate its position in the blind area. Because the location of object 217 is not relevant to the ADV and its current path, the ADV does not have to react to the object. This can reduce overhead and improve computational efficiency.

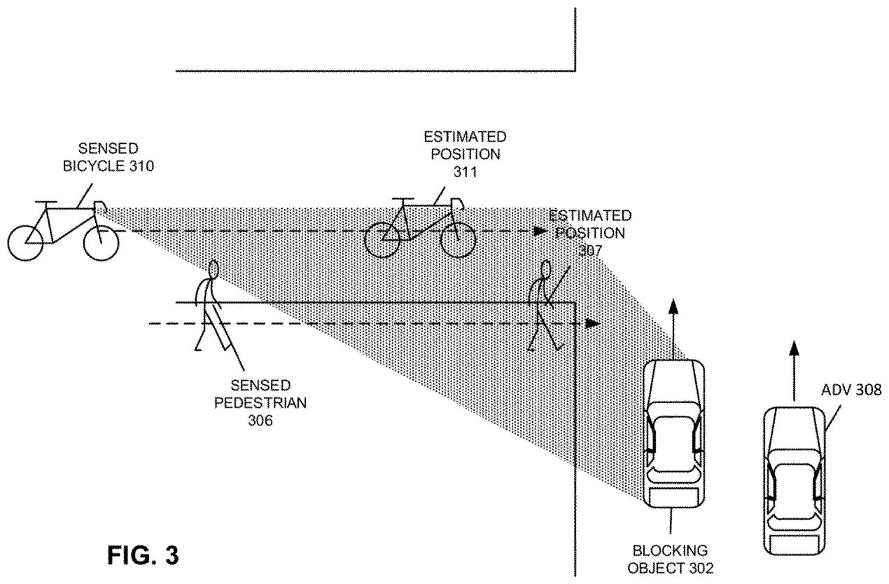

Aspects described in the present disclosure for predicting or estimating positions of vehicles (e.g., based on prior movement history, map information, predicted trajectories, traffic rules, etc.) also pertain to other objects, such as cyclists and pedestrians that are blocked in a blind area. For example, as shown in FIG. 3, an ADV 308 can estimate positions (311, 307) of cyclists and pedestrians (310, 306) that are in a blind area, being blocked by an object 302 in the same manners described with reference to FIG. 1 and FIG. 2. In addition, FIG. 3 shows that a blocking object can be a dynamic (moving) object such as a car or truck. Aspects described in relation to static blocking objects (such as buildings) also apply to dynamic blocking objects, and vice versa.

In one embodiment, the position of the object in the blind area is further determined based on a classification of the object. For example, the second object can be recognized with a machine learning algorithm (e.g., a trained neural network), as a cyclist, a pedestrian, or an automobile. Different traffic rules and behaviors can be applied based on the recognized classification, to determine the position of the object. The object classification may be performed using a neural network predictive model based on a set of features extracted from captured images of the driving environment, i.e., images captured by a camera, point cloud captured by a LIDAR device.

For example, a pedestrian may be slowed down due to a ‘don't walk’ traffic light, which would not have relevance to an automobile or cyclist. The speeds used to determine the positions can also be specific to the classifications, for example, a speed range of 2.5 to 8 mph may be applied to a pedestrian in a blind area, where a cyclist or automobile can have a significantly higher speed. A cyclist may be more likely than an automobile to alter its path from riding on the road to riding on a sidewalk.

Furthermore, an object or obstacle can be classified as an emergency vehicle such as, for example, a fire truck, police car, ambulance, or other emergency vehicle. Sensors of the ADV (e.g., one or microphones and/or cameras) can sense whether the vehicle has sirens on, which can factor into whether or not the vehicle is likely to slow down or stop at a red light. For example, if a police car, fire truck, or ambulance has turned emergency sirens on, it may slow at a red light, but drive through it. The ADV can modify its controls accordingly (e.g., come to a stop and/or pull over to the sidewalk).

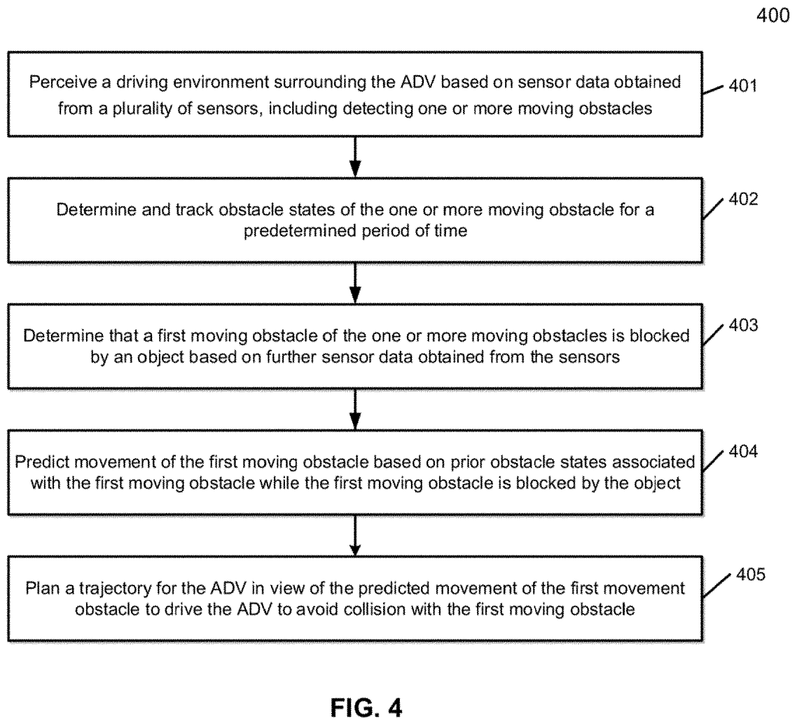

FIG. 4 shows a process 400 for handling blind areas for autonomous driving according to one embodiment. Process 400 may be performed by processing logic, which may include software, hardware, or a combination thereof. For example, process 400 may be performed by a planning module of an ADV such as planning module 805 of FIG. 8, which will be described in details further below. Referring to FIG. 4, at block 401, Processing logic perceives a driving environment surrounding an ADV based on sensor data obtained from various sensors of the ADV, including detecting one or more moving obstacles. At block 402, the obstacle states (e.g., location, speed, and heading direction) of each moving obstacle is determined and tracked, which may be maintained in memory or a persistent storage device for a period of time. At block 403, the processing logic determines that a first moving obstacle is blocked by another object based on the further sensor data. In response, at block 404, processing logic predicts the further movement of the first moving obstacle based on the previously tracked obstacle states of the first moving obstacle, while the first moving obstacle is blocked by the object. At block 405, a trajectory for driving the ADV is planned in view of the predicted movement of the first moving obstacle, for example, to avoid the collision with the object.

In one embodiment, multiple possible movements can be determined for a single blocked object in a blind area. For example, if the object was arced, one possible trajectory is to continue the arc. Another possible trajectory is for the object to straighten out. In addition, a fork in the road may be present in the blind area. Similarly, multiple possible speeds can be determined for the same object. For example, if the vehicle is determined to be decelerating prior to entering a blind area, the vehicle speed can be estimated at different locations and times based on the deceleration. Other factors, such as traffic signs, intersections, traffic lights, other vehicles, etc., can also be factored into the estimation process.

The ADV can react according to the multiple possibilities, for example, by determining controls that would provide safety optimized driving for the different possible speeds, trajectories, and positions of the single object. Additionally or alternatively, the blind area processor can determine a most likely scenario, or rank the different possible scenarios in terms of likelihood. In one aspect, a machine learning algorithm can be implemented (e.g., a trained neural network) to select optimized driving controls, and rank or select the likeliness of different scenarios (which determine the possible trajectory, speed, position of the blocked object). Other heuristically based algorithms can be employed based on ranked importance of various factors (e.g., traffic signs, traffic lights, other sensed objects, traffic rules and map information).

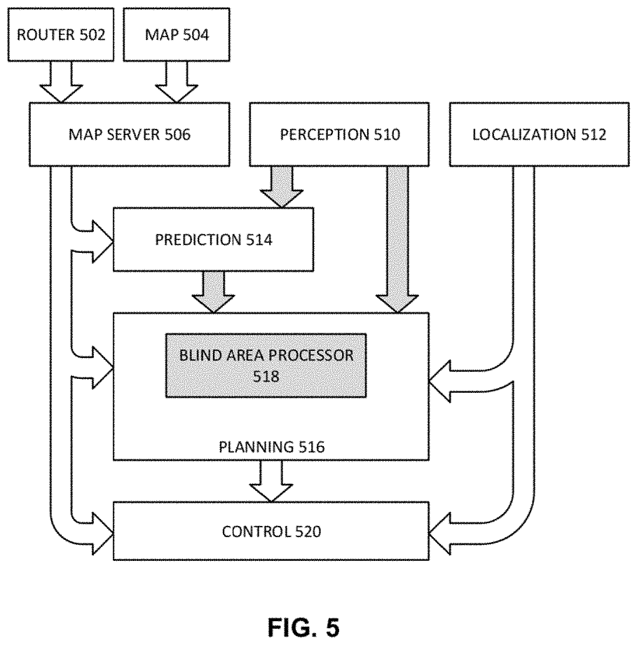

FIG. 5 is a block diagram illustrating autonomous driving system architecture according to one embodiment. A router 502 and map 504 is provided to a map server 506 which can determine a path for the ADV to reach a destination. The path can be provided to a prediction module 514, and a planning module 516, of which a blind area processor 518 can be integral to. The path can also be provided to a vehicle control module 520.

A perception module provides perceived information (e.g., by processing data from sensors), including which objects are perceived in the ADV's environment and how such objects are moving, to a prediction module 514 which can predict future movements of the perceived objects. The perception module can provide the perceived information to the planning module (and blind area processor). Thus, the perception module can process sensor data to recognize a blocking object and a second object moving into a blind area, and a direction, speed, acceleration, and/or trajectory of the second object prior to moving into the blind area. This information can be provided to the blind area processor to determine the position of the second object in the blind area, as described in this disclosure. Similarly, the prediction module 514 can be leveraged to predict how objects in the blind area may behave, e.g., based on classifications, traffic rules, map information, traffic lights and signs, etc. These modules are described in further detail below.

FIG. 6 is a block diagram illustrating an autonomous driving vehicle according to one embodiment of the disclosure. ADV 600 may represent any of the ADVs described above. Referring to FIG. 6, autonomous driving vehicle 601 may be communicatively coupled to one or more servers over a network, which may be any type of networks such as a local area network (LAN), a wide area network (WAN) such as the Internet, a cellular network, a satellite network, or a combination thereof, wired or wireless. The server(s) may be any kind of servers or a cluster of servers, such as Web or cloud servers, application servers, backend servers, or a combination thereof. A server may be a data analytics server, a content server, a traffic information server, a map and point of interest (MPOI) server, or a location server, etc.

An autonomous driving vehicle refers to a vehicle that can be configured to in an autonomous mode in which the vehicle navigates through an environment with little or no input from a driver. Such an autonomous driving vehicle can include a sensor system having one or more sensors that are configured to detect information about the environment in which the vehicle operates. The vehicle and its associated controller(s) use the detected information to navigate through the environment. Autonomous driving vehicle 601 can operate in a manual mode, a full autonomous mode, or a partial autonomous mode.

In one embodiment, autonomous driving vehicle 601 includes, but is not limited to, perception and planning system 610, vehicle control system 611, wireless communication system 612, user interface system 613, and sensor system 615. Autonomous driving vehicle 601 may further include certain common components included in ordinary vehicles, such as, an engine, wheels, steering wheel, transmission, etc., which may be controlled by vehicle control system 611 and/or perception and planning system 610 using a variety of communication signals and/or commands, such as, for example, acceleration signals or commands, deceleration signals or commands, steering signals or commands, braking signals or commands, etc.

Components 610-615 may be communicatively coupled to each other via an interconnect, a bus, a network, or a combination thereof. For example, components 610-615 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

Referring now to FIG. 7, in one embodiment, sensor system 615 includes, but it is not limited to, one or more cameras 711, global positioning system (GPS) unit 712, inertial measurement unit (IMU) 713, radar unit 714, and a light detection and range (LIDAR) unit 715. GPS system 712 may include a transceiver operable to provide information regarding the position of the autonomous driving vehicle. IMU unit 713 may sense position and orientation changes of the autonomous driving vehicle based on inertial acceleration. Radar unit 714 may represent a system that utilizes radio signals to sense objects within the local environment of the autonomous driving vehicle. In some embodiments, in addition to sensing objects, radar unit 714 may additionally sense the speed and/or heading of the objects. LIDAR unit 715 may sense objects in the environment in which the autonomous driving vehicle is located using lasers. LIDAR unit 715 could include one or more laser sources, a laser scanner, and one or more detectors, among other system components. Cameras 711 may include one or more devices to capture images of the environment surrounding the autonomous driving vehicle. Cameras 711 may be still cameras and/or video cameras. A camera may be mechanically movable, for example, by mounting the camera on a rotating and/or tilting a platform.

Sensor system 615 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous driving vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

The various sensors may be used, for example, to determine movement information of objects prior to entering a blind area. The movement information can then be extrapolated to determine movement information (e.g., heading, speed, acceleration, position) of objects in the blind area.

In one embodiment, vehicle control system 611 includes, but is not limited to, steering unit 701, throttle unit 702 (also referred to as an acceleration unit), and braking unit 703. Steering unit 701 is to adjust the direction or heading of the vehicle. Throttle unit 702 is to control the speed of the motor or engine that in turn controls the speed and acceleration of the vehicle. Braking unit 703 is to decelerate the vehicle by providing friction to slow the wheels or tires of the vehicle. Note that the components as shown in FIG. 7 may be implemented in hardware, software, or a combination thereof.

Referring back to FIG. 6, wireless communication system 612 is to allow communication between autonomous driving vehicle 601 and external systems, such as devices, sensors, other vehicles, etc. For example, wireless communication system 612 can wirelessly communicate with one or more devices directly or via a communication network. Wireless communication system 612 can use any cellular communication network or a wireless local area network (WLAN), e.g., using WiFi to communicate with another component or system. Wireless communication system 612 could communicate directly with a device (e.g., a mobile device of a passenger, a display device, a speaker within vehicle 601), for example, using an infrared link, Bluetooth, etc. User interface system 613 may be part of peripheral devices implemented within vehicle 601 including, for example, a keyboard, a touch screen display device, a microphone, and a speaker, etc.

Some or all of the functions of autonomous driving vehicle 601 may be controlled or managed by perception and planning system 610, especially when operating in an autonomous driving mode. Perception and planning system 610 includes the necessary hardware (e.g., processor(s), memory, storage) and software (e.g., operating system, planning and routing programs) to receive information from sensor system 615, control system 611, wireless communication system 612, and/or user interface system 613, process the received information, plan a route or path from a starting point to a destination point, and then drive vehicle 601 based on the planning and control information. Alternatively, perception and planning system 610 may be integrated with vehicle control system 611.

For example, a user as a passenger may specify a starting location and a destination of a trip, for example, via a user interface. Perception and planning system 610 obtains the trip related data. For example, perception and planning system 610 may obtain location and route information from an MPOI server. The location server provides location services and the MPOI server provides map services and the POIs of certain locations. Alternatively, such location and MPOI information may be cached locally in a persistent storage device of perception and planning system 610.

While autonomous driving vehicle 601 is moving along the route, perception and planning system 610 may also obtain real-time traffic information from a traffic information system or server (TIS). Note that the servers may be operated by a third party entity. Alternatively, the functionalities of the servers may be integrated with perception and planning system 610. Based on the real-time traffic information, MPOI information, and location information, as well as real-time local environment data detected or sensed by sensor system 615 (e.g., obstacles, objects, nearby vehicles), perception and planning system 610 can plan an optimal route and drive vehicle 601, for example, via control system 611, according to the planned route to reach the specified destination safely and efficiently.

FIG. 8 is a block diagram illustrating an example of a perception and planning system used with an autonomous driving vehicle according to one embodiment. System 800 may be implemented as a part of autonomous driving vehicle 601 of FIG. 6 including, but is not limited to, perception and planning system 610, control system 611, and sensor system 615. Referring to FIG. 8, perception and planning system 610 includes, but is not limited to, localization module 801, perception module 802, prediction module 803, decision module 804, planning module 805, control module 806, routing module 807, object tracking module 808, and blind area processor 820.

Some or all of modules 801-808 and 820 may be implemented in software, hardware, or a combination thereof. For example, these modules may be installed in persistent storage device 852, loaded into memory 851, and executed by one or more processors (not shown). Note that some or all of these modules may be communicatively coupled to or integrated with some or all modules of vehicle control system 611 of FIG. 7. Some of modules 801-808 and 820 may be integrated together as an integrated module.

Localization module 801 determines a current location of autonomous driving vehicle 300 (e.g., leveraging GPS unit 712) and manages any data related to a trip or route of a user. Localization module 801 (also referred to as a map and route module) manages any data related to a trip or route of a user. A user may log in and specify a starting location and a destination of a trip, for example, via a user interface. Localization module 801 communicates with other components of autonomous driving vehicle 300, such as map and route information 811, to obtain the trip related data. For example, localization module 801 may obtain location and route information from a location server and a map and POI (MPOI) server. A location server provides location services and an MPOI server provides map services and the POIs of certain locations, which may be cached as part of map and route information 811. While autonomous driving vehicle 300 is moving along the route, localization module 801 may also obtain real-time traffic information from a traffic information system or server.

Based on the sensor data provided by sensor system 615 and localization information obtained by localization module 801, a perception of the surrounding environment is determined by perception module 802. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 802 may include a computer vision system or functionalities of a computer vision system to process and analyze images captured by one or more cameras in order to identify objects and/or features in the environment of autonomous driving vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. In addition to processing images from the one or more cameras, perception module 802 can also detect objects based on sensors data provided by other sensors such as a radar and/or LIDAR. Data from the various sensors can be combined and compared to affirm or refute detected objects to improve the accuracy of object detection and identification.

For each of the objects, prediction module 803 predicts how the object will behave under the circumstances. The prediction is performed based on the perception data perceiving the driving environment at the point in time in view of a set of map/rout information 811 and traffic rules 812. For example, if the object is a vehicle at an opposing direction and the current driving environment includes an intersection, prediction module 803 will predict whether the vehicle will likely move straight forward or make a turn. If the perception data indicates that the intersection has no traffic light, prediction module 803 may predict that the vehicle may have to fully stop prior to entering the intersection. If the perception data indicates that the vehicle is currently at a left-turn only lane or a right-turn only lane, prediction module 803 may predict that the vehicle will more likely make a left turn or right turn respectively. Similarly, the blind area processor 820 can leverage the algorithms of the prediction module to predict how an object in a blind area might behave, while also factoring the last sensed movements of the object.

For each of the objects, decision module 804 makes a decision regarding how to handle the object. For example, for a particular object (e.g., another vehicle in a crossing route) as well as its metadata describing the object (e.g., a speed, direction, turning angle), decision module 804 decides how to encounter the object (e.g., overtake, yield, stop, pass). Decision module 804 may make such decisions according to a set of rules such as traffic rules or driving rules 812, which may be stored in persistent storage device 852.

Routing module 807 is configured to provide one or more routes or paths from a starting point to a destination point. For a given trip from a start location to a destination location, for example, received from a user, routing module 807 obtains route and map information 811 and determines all possible routes or paths from the starting location to reach the destination location. Routing module 807 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 804 and/or planning module 805. Decision module 804 and/or planning module 805 examine all of the possible routes to select and modify one of the most optimal routes in view of other data provided by other modules such as traffic conditions from localization module 801, driving environment perceived by perception module 802, and traffic condition predicted by prediction module 803. The actual path or route for controlling the ADV may be close to or different from the reference line provided by routing module 807 dependent upon the specific driving environment at the point in time.

Based on a decision for each of the objects perceived, planning module 805 plans a path or route for the autonomous driving vehicle, as well as driving parameters (e.g., distance, speed, and/or turning angle), using a reference line provided by routing module 807 as a basis. That is, for a given object, decision module 804 decides what to do with the object, while planning module 805 determines how to do it. For example, for a given object, decision module 804 may decide to pass the object, while planning module 805 may determine whether to pass on the left side or right side of the object. Planning and control data is generated by planning module 805 including information describing how vehicle 300 would move in a next moving cycle (e.g., next route/path segment). For example, the planning and control data may instruct vehicle 300 to move 10 meters at a speed of 30 mile per hour (mph), then change to a right lane at the speed of 25 mph.

Based on the planning and control data, control module 806 controls and drives the autonomous driving vehicle, by sending proper commands or signals to vehicle control system 611, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 805 plans a next route segment or path segment, for example, including a target position and the time required for the ADV to reach the target position. Alternatively, planning module 805 may further specify the specific speed, direction, and/or steering angle, etc. In one embodiment, planning module 805 plans a route segment or path segment for the next predetermined period of time such as 5 seconds. For each planning cycle, planning module 805 plans a target position for the current cycle (e.g., next 5 seconds) based on a target position planned in a previous cycle. Control module 806 then generates one or more control commands (e.g., throttle, brake, steering control commands) based on the planning and control data of the current cycle.

Note that decision module 804 and planning module 805 may be integrated as an integrated module. Decision module 804/planning module 805 may include a navigation system or functionalities of a navigation system to determine a driving path for the autonomous driving vehicle. For example, the navigation system may determine a series of speeds and directional headings to affect movement of the autonomous driving vehicle along a path that substantially avoids perceived obstacles while generally advancing the autonomous driving vehicle along a roadway-based path leading to an ultimate destination. The destination may be set according to user inputs via user interface system 613. The navigation system may update the driving path dynamically while the autonomous driving vehicle is in operation. The navigation system can incorporate data from a GPS system and one or more maps so as to determine the driving path for the autonomous driving vehicle.

According to one embodiment, object tracking module 808 is configured to track the movement history of obstacles detected by perception module 802, as well as the movement history of the ADV. The object tracking module 808 may be implemented as part of perception module 802. The movement history of obstacles and the ADV may be stored in respective obstacle and vehicle state buffers maintained in memory 851 and/or persistent storage device 852 as part of driving statistics 813. For each obstacle detected by perception module 802, obstacles states at different points in time over a predetermined time period is determined and maintained in an obstacle state buffer associated with the obstacle maintained in memory 851 for quick access. The obstacle states may further be flushed and stored in persistent storage device 852 as a part of driving statistics 813. The obstacle states maintained in memory 851 may maintained for a shorter time period, while the obstacles states stored in persistent storage device 852 may be maintained for a longer time period. Similarly, the vehicle states of the ADV can also be maintained in both memory 851 and persistent storage device 852 as a part of driving statistics 813.

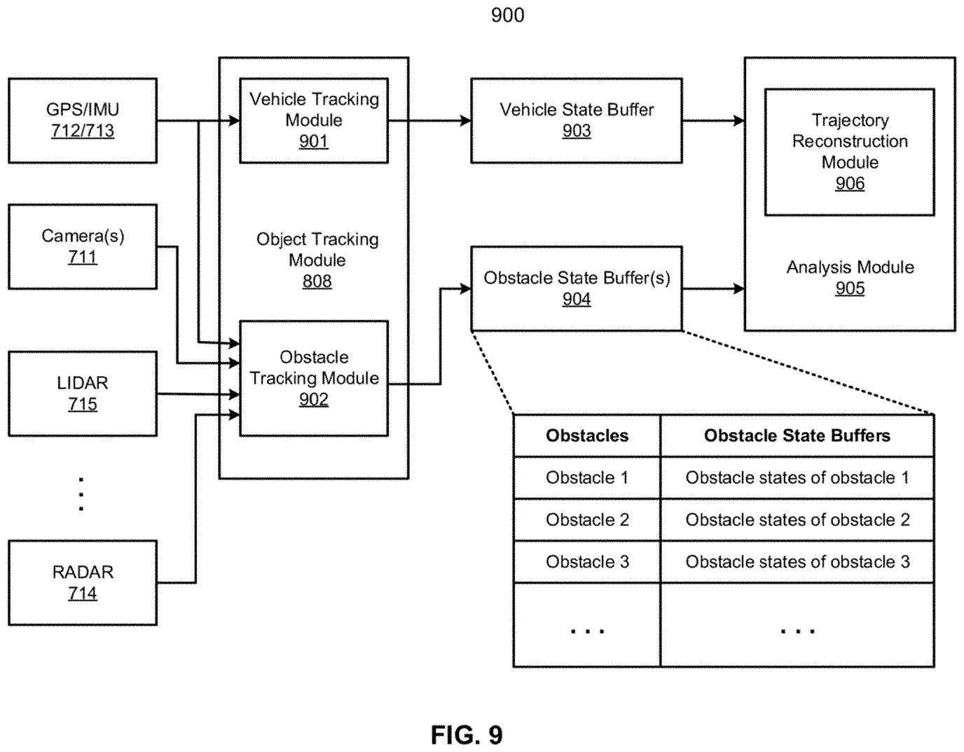

FIG. 9 is a block diagram illustrating an object tracking system according to one embodiment. Referring to FIG. 9, object tracking module 808 includes vehicle tracking module 901 and obstacle tracking module 902, which may be implemented as an integrated module. Vehicle tracking module 901 is configured to track the movement of the ADV based on at least GPS signals received from GPS 712 and/or IMU signals received from IMU 713. Vehicle tracking module 901 may perform a motion estimation based on the GPS/MU signals to determine the vehicle states such as locations, speeds, and heading directions at different points in time. The vehicle states are then stored in vehicle state buffer 903. In one embodiment, vehicle states stored in vehicle state buffer 903 may only contain the locations of the vehicle at different points in time with fixed time increments. Thus, based on the locations at the fixed incremented timestamps, the speed and the heading direction may be derived. Alternatively, a vehicle state may include a rich set of vehicle state metadata including, a location, speed, heading direction, acceleration/deceleration, as well as the control commands issued.

In one embodiment, obstacle tracking module 902 is configured to track the obstacles detected based on sensor data obtained from various sensors, such as, for example, cameras 911, LIDAR 915, and/or RADAR 914. Obstacle tracking module 902 may include a camera object detector/tracking module and a LIDAR object detector/tracking module to detect and track an obstacle captured by an image and an obstacle captured by a LIDAR point cloud respectively. A data fusion operation may be performed on the outputs provided by the camera and LIDAR object detector/tracking modules. In one embodiment, the camera and LIDAR object detector/tracking modules may be implemented in a neural network predictive model to predict and track the movements of the obstacles. The obstacle states of obstacles are then stored obstacle state buffers 904. An obstacle state is similar or identical to a vehicle state as described above.

In one embodiment, for each of the obstacles detected, an obstacle state buffer is allocated to specifically store the obstacle states of the corresponding obstacle. In one embodiment, each of the vehicle state buffer and obstacle state buffers is implemented as a circular buffer, similar to a first-in-first-out (FIFO) buffer, to maintain a predetermined amount of data associated with a predetermined time period. The obstacle states stored in the obstacle state buffers 904 can be utilized to predict future movements of the obstacles, such that a better path for the ADV can be planned to avoid the collision with the obstacles.

For example, under certain circumstances, an obstacle may be blocked by another object that the ADV cannot “see.” However, based on the past obstacle states of the obstacle, a further moving trajectory may be predicted, even though the obstacle is out of sight as described above. This is important because an obstacle may be in a blind spot for a moment and the ADV needs to plan by considering the future locations of the obstacle to avoid the potential collision. Alternatively, traffic flows or traffic congestion may be determined based on the trajectories of the obstacles.

According to one embodiment, obstacle states stored in obstacle state buffer 904 and vehicle states stored in vehicle state buffer 903 may be analyzed subsequently or in real-time by analysis module 905 for a variety of reasons. For example, the obstacle states of an obstacle over a period of time can be utilized to reconstruct a trajectory in the past the obstacle has moved by trajectory reconstruction module 906. The reconstructed trajectories of one or more obstacles in the driving environment can be utilized to determine or predict the lane configuration of a road by creating a virtual lane. A lane configuration may include a number of lanes, a lane width, a lane shape or curvature, and/or a lane center line. For example, based on the traffic flows of multiple streams of obstacle flows, a number of lanes can be determined. In addition, an obstacle or moving object moves at the center of a lane in general. Thus by tracking the moving trajectory of an obstacle, a lane center line can be predicted. Further, a lane width can also be determined based on the predicted lane center line by observing the obstacle width plus a minimum clearance space required by the government regulation. Such lane configuration prediction is particular useful when the ADV is driving in a rural area, where the lane markings are unavailable or insufficiently clear.

According to another embodiment, if there is a need for following or tailgating another moving obstacle, the past moving trajectory of that obstacle can be reconstructed based on the obstacle states retrieved from the corresponding obstacle state buffer. A path for tailgating can then be planned based on the reconstructed trajectory of the obstacle to be followed.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method for operating an autonomous driving vehicle (ADV), the method comprising:
perceiving a driving environment surrounding the ADV based on sensor data obtained from a plurality of sensors, including detecting one or more moving obstacles;
determining and tracking obstacle states of the one or more moving obstacle for a predetermined period of time;
determining that a first moving obstacle of the one or more moving obstacles is blocked by an object based on further sensor data obtained from the sensors;
predicting movement of the first moving obstacle based on prior obstacle states associated with the first moving obstacle while the first moving obstacle is blocked by the object; and
planning a trajectory for the ADV in view of the predicted movement of the first movement obstacle to drive the ADV to avoid collision with the first moving obstacle.

2. The method of claim 1, wherein tracking obstacle states of the one or more moving obstacle comprises:
for each of the one or more moving obstacles perceived, allocate an obstacle buffer; and
storing in the allocated obstacle state buffer obstacle states of the moving obstacle at different points in time.

3. The method of claim 1, wherein each obstacle state comprises a location, a speed, and heading direction of the corresponding moving obstacle at a particular point in time.

4. The method of claim 1, wherein predicting movement of the first moving obstacle comprises:
reconstructing a moving trajectory of the first moving obstacles based on the obstacle states of the first moving obstacle; and
predicting further movement of the first moving obstacle based on the reconstructed moving trajectory of the first moving obstacle.

5. The method of claim 1, further comprising determining lane configuration of one or more lanes based on obstacle states of the one or more moving obstacles, wherein the movement of the first moving obstacle is predicted further based on the lane configuration.

6. The method of claim 1, further comprising determining traffic flows of the driving environment based on obstacle states of the one or more moving obstacles, wherein the movement of the first moving obstacle is predicted further based on the traffic flows.

7. The method of claim 1, wherein predicting the movement of the first moving obstacle is performed further based on map information and traffic rules.

8. The method of claim 1, wherein predicting the movement of the first moving obstacle includes predicting slowing or stopping of the first moving obstacle based on a traffic light, stop sign, or intersection perceived in the driving environment.

9. A non-transitory machine-readable medium having instructions stored therein, which when executed by a processor, cause the processor to perform operations, the operations comprising:
perceiving a driving environment surrounding the ADV based on sensor data obtained from a plurality of sensors, including detecting one or more moving obstacles;
determining and tracking obstacle states of the one or more moving obstacle for a predetermined period of time;
determining that a first moving obstacle of the one or more moving obstacles is blocked by an object based on further sensor data obtained from the sensors;
predicting movement of the first moving obstacle based on prior obstacle states associated with the first moving obstacle while the first moving obstacle is blocked by the object; and
planning a trajectory for the ADV in view of the predicted movement of the first movement obstacle to drive the ADV to avoid collision with the first moving obstacle.

10. The machine-readable medium of claim 9, wherein tracking obstacle states of the one or more moving obstacle comprises:
for each of the one or more moving obstacles perceived, allocate an obstacle buffer; and
storing in the allocated obstacle state buffer obstacle states of the moving obstacle at different points in time.

11. The machine-readable medium of claim 9, wherein each obstacle state comprises a location, a speed, and heading direction of the corresponding moving obstacle at a particular point in time.

12. The machine-readable medium of claim 9, wherein predicting movement of the first moving obstacle comprises:
reconstructing a moving trajectory of the first moving obstacles based on the obstacle states of the first moving obstacle; and
predicting further movement of the first moving obstacle based on the reconstructed moving trajectory of the first moving obstacle.

13. The machine-readable medium of claim 9, wherein the operations further comprise determining lane configuration of one or more lanes based on obstacle states of the one or more moving obstacles, wherein the movement of the first moving obstacle is predicted further based on the lane configuration.

14. The machine-readable medium of claim 9, wherein the operations further comprise determining traffic flows of the driving environment based on obstacle states of the one or more moving obstacles, wherein the movement of the first moving obstacle is predicted further based on the traffic flows.

15. The machine-readable medium of claim 9, wherein predicting the movement of the first moving obstacle is performed further based on map information and traffic rules.

16. The machine-readable medium of claim 9, wherein predicting the movement of the first moving obstacle includes predicting slowing or stopping of the first moving obstacle based on a traffic light, stop sign, or intersection perceived in the driving environment.

17. A data processing system, comprising:
a processor; and
a memory coupled to the processor to store instructions, which when executed by the processor, cause the processor to perform operations, the operations including
perceiving a driving environment surrounding the ADV based on sensor data obtained from a plurality of sensors, including detecting one or more moving obstacles,
determining and tracking obstacle states of the one or more moving obstacle for a predetermined period of time,
determining that a first moving obstacle of the one or more moving obstacles is blocked by an object based on further sensor data obtained from the sensors,
predicting movement of the first moving obstacle based on prior obstacle states associated with the first moving obstacle while the first moving obstacle is blocked by the object, and
planning a trajectory for the ADV in view of the predicted movement of the first movement obstacle to drive the ADV to avoid collision with the first moving obstacle.

18. The system of claim 17, wherein tracking obstacle states of the one or more moving obstacle comprises:
for each of the one or more moving obstacles perceived, allocate an obstacle buffer; and
storing in the allocated obstacle state buffer obstacle states of the moving obstacle at different points in time.

19. The system of claim 17, wherein each obstacle state comprises a location, a speed, and heading direction of the corresponding moving obstacle at a particular point in time.

20. The system of claim 17, wherein predicting movement of the first moving obstacle comprises:
reconstructing a moving trajectory of the first moving obstacles based on the obstacle states of the first moving obstacle; and
predicting further movement of the first moving obstacle based on the reconstructed moving trajectory of the first moving obstacle.
